(19) United States
(12) Patent Application Publication
(10) Pub. No.: US 2020/0279060 A1
(43) Pub. Date: Sep. 3, 2020

(54) Secure Storage Over Fabric

(71) Applicant: HEWLETT PACKARD ENTERPRISE DEVELOPMENT LP, Houston, TX (US)

(72) Inventor: Montgomery C. McGraw, Magnolia, TX (US)

(21) Appl. No.: 16/288,230

(22) Filed: Feb. 28, 2019

(51) Int. Cl. G06F 21/78; H04L 29/06; G06F 21/62; G06F 21/60

(52) U.S. Cl. CPC G06F 21/78; G06F 21/602; G06F 21/6209; H04L 63/0428

(57) ABSTRACT

A method for securing storage over a fabric connection includes receiving a request to store data using a storage module that is connected with a compute node over a fabric. The method also includes encrypting the data on the compute node. Additionally, the method includes sending the encrypted data from the compute node to the storage module over the fabric.

### BACKGROUND

In computing, disaggregated storage may refer to hard disk drives, virtual drives, or any drives that store information external to a computer. Disaggregated storage may provide the convenience of expanding the amount of data one computer can store and access without having to buy a new computer with larger local storage. Disaggregated storage may be cabled to the computer, either directly cabled or cabled through storage fabric switches. Although storage data at rest within a drive may be protected by encryption within the drive, disaggregated storage exposes the data in flight over a fabric to snooping attack.

### BRIEF DESCRIPTION OF THE DRAWINGS

The present disclosure may be understood from the following detailed description when read with the accompanying Figures. In accordance with the standard practice in the industry, various features are not drawn to scale. In fact, the dimensions of the various features may be arbitrarily increased or reduced for clarity of discussion.

Some examples of the present application are described with respect to the following figures.

FIG. 1A is an example system for secure storage over fabric, according to one or more examples described.

FIG. 1B is an example system for secure storage over fabric, according to one or more examples described.

FIG. 1C is an example system for secure storage over fabric, according to one or more examples described.

FIG. 1D is an example system for secure storage over fabric, according to one or more examples described.

FIG. 1E is an example system for secure storage over fabric, according to one or more examples described.

FIG. 1F is an example system for secure storage over fabric, according to one or more examples described.

FIG. 1G is an example system for secure storage over fabric, according to one or more examples described.

FIG. 1H is an example system for secure storage over fabric, according to one or more examples described.

FIG. 1I is an example system for secure storage over fabric, according to one or more examples described.

FIG. 2 is an example system for secure storage over fabric, according to one or more examples described.

FIG. 3 is an example system for secure storage over fabric, according to one or more examples described.

FIG. 4 is a process flow diagram of an example method for secure storage over fabric, according to one or more examples described.

FIG. 5 is an example system comprising a tangible, non-transitory computer-readable medium that stores code for secure storage over fabric, according to one or more examples described.

### DETAILED DESCRIPTION

Storage over fabric enables one or more computers to access one or more storage devices attached to one or more storage enclosures, and or one or more other computers using a fabric. The term, fabric, refers to, at least in part, the communication network that may be used between the one or more computers and the one or more storage devices. The communication network may use communication and transport protocols for data that may include Ethernet, Fibre Channel, lnfiniband℠, Gen-Z, and the like. Storage over fabric scales the storage accessible to a computer through disaggregation to one or more storage enclosures. The one or more storage enclosures, also referred to herein as a storage module. The one or more storage modules may include a disaggregated array of independent storage from the fabric to comprise a redundant array of independent disks. The one or more storage modules may include one or more storage devices. The one or more storage devices may include one or more memory devices, one or more drives, and or an array of independent drives. The one or more memory devices may include a circuit board of integrated circuits for computer memory. The one or more memory devices may be redundant to or may provide a redundant memory backup for at least a portion of the memory of the one or more drives and or the array of independent drives. The one or more drives and or the array of independent drives may be redundant to or may provide a redundant memory backup for at least a portion of the memory of the one or more memory devices. The drives may be rotating disk drives, solid state drives, redundant arrays of independent disks (RAID), virtual drives, and the like. The one or more memory devices may include one or more flash drives, one or more single in-line memory modules (SIMM), one or more dual in-line memory modules (DIMM), and or the like.

The Ethernet communication and transport protocol for data may operate within a physical layer and a data link layer on an open systems interconnection network protocol model. The Ethernet communication and transport protocol may include two units of transmission, a packet and a frame. The frame may include the payload of data being transmitted as well as the physical media access control (MAC) addresses of both the sender and receiver, virtual local area network (VLAN) tagging, quality of service information, and error correction information. Each packet may include a frame and additional information to establish a connection and mark where the frame starts. The Fibre Channel communication and transport protocol may include data link layer switching technologies where hardware may handle the entire protocol in a Fibre Channel fabric. The Infiniband communication and transport protocol may include a switch-based serial point-to-point interconnect architecture where data may be transmitted in packets that form a message. The Infiniband communication and transport protocol may include remote direct memory access support, simultaneous peer-to-peer communication, and end-to-end flow control. The Gen-Z communication and transport protocol may be an open-systems interconnect that may provide memory semantic access to data and devices via direct-attached, switched, or fabric topologies. The Gen-Z communication and transport protocol may enable any type and mix of dynamic random-access memory (DRAM) and non-volatile memory to be directly accessed by applications or through block-semantic communications.

However, the use of networks means that malicious users may be able to snoop on the data in flight. The term, in flight, refers to the data in the active state of passing over the network between the computer and the disaggregated storage modules. Currently, disaggregated storage modules do not protect the data in flight over any fabric. This may expose the data to snooping attacks.

Further, some disaggregated storage modules do not protect the data at rest. The term, at rest, refers to the data in the static state of storage on the disaggregated storage module drives. Because the data at rest is not protected, the data on the storage modules may be read offline if the drives are physically removed.

In some cases, the disaggregated storage modules may provide encryption of the data at rest. However, in such cases, the data in flight may still be transmitted without encryption and therefore be exposed to snooping. In addition, the data may pass unencrypted through a memory of the disaggregated storage module, and therefore be subject to potential theft if the memory is physically removed. Further, if the disaggregated storage module uses the same encryption key for all the data at rest on the drives in the storage modules, all the data at rest may be exposed to offline snooping if the drives of the storage modules are physically removed and the single encryption key is stolen.

Additionally, storage modules may provide disaggregated storage for multiple computers, compute nodes, and the like. As such, if the storage module provides encryption for the data in flight but uses a single encryption key for all the data, then theft of the single encryption key may expose the data in flight of all the compute nodes to snooping. However, if the storage module uses a different encryption key for the data in flight for every compute node, the additional processing overhead on the storage module may detrimentally impact the throughput and latency of storage and access.

Accordingly, examples of the present disclosure may provide encryption for data in flight over fabric, and at rest on disaggregated storage. In addition, examples may provide storage performance scalability of disaggregated storage modules by distributing the encryption to the computers that are storing their data on, and accessing their data from, the disaggregated storage. Herein, these computers are referred to as initiators. Providing encryption at the initiators provides an improvement in performance over encryption as a service on the disaggregated storage modules. In examples, data may be encrypted and decrypted at the initiator's connection to the fabric. Further, this approach may be applied to any system with fabric-connected storage including, but not limited to, non-volatile memory express (NVMe) external storage and Gen-Z persistent memory.

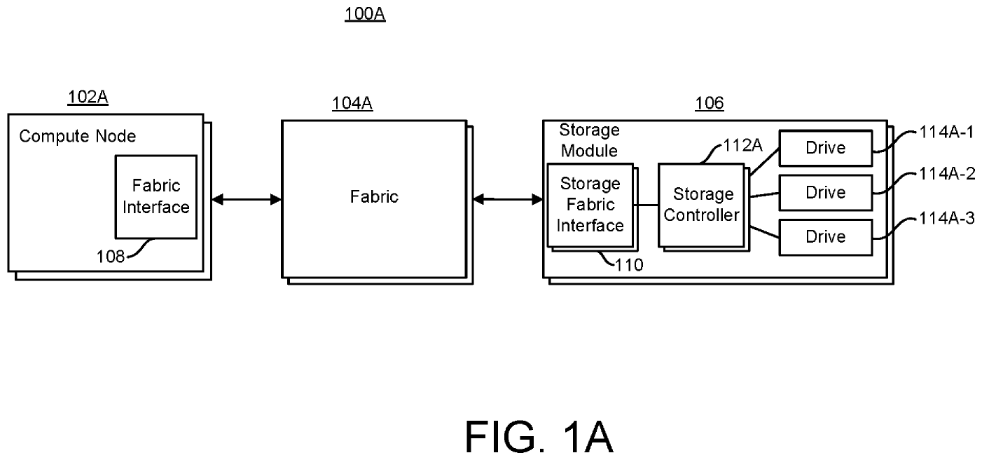

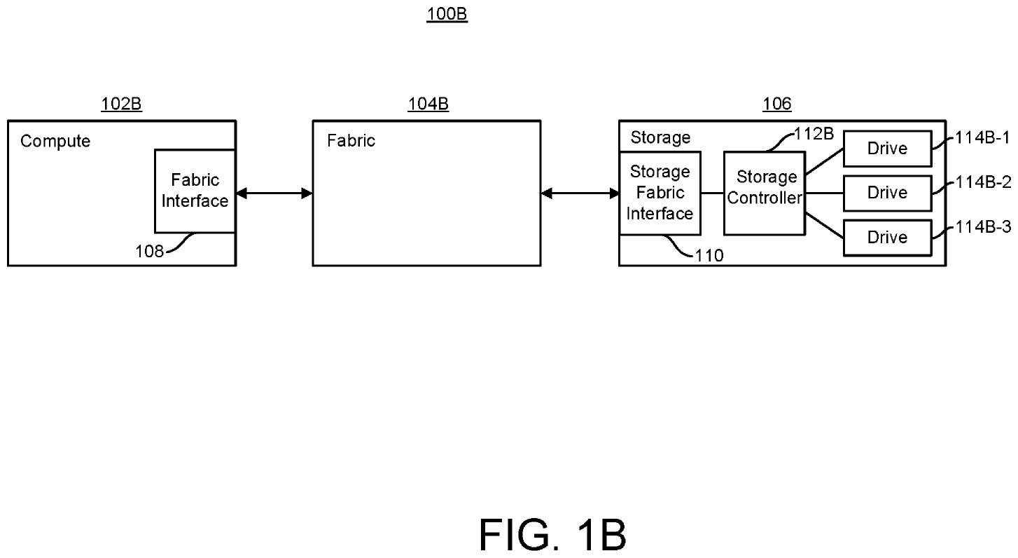

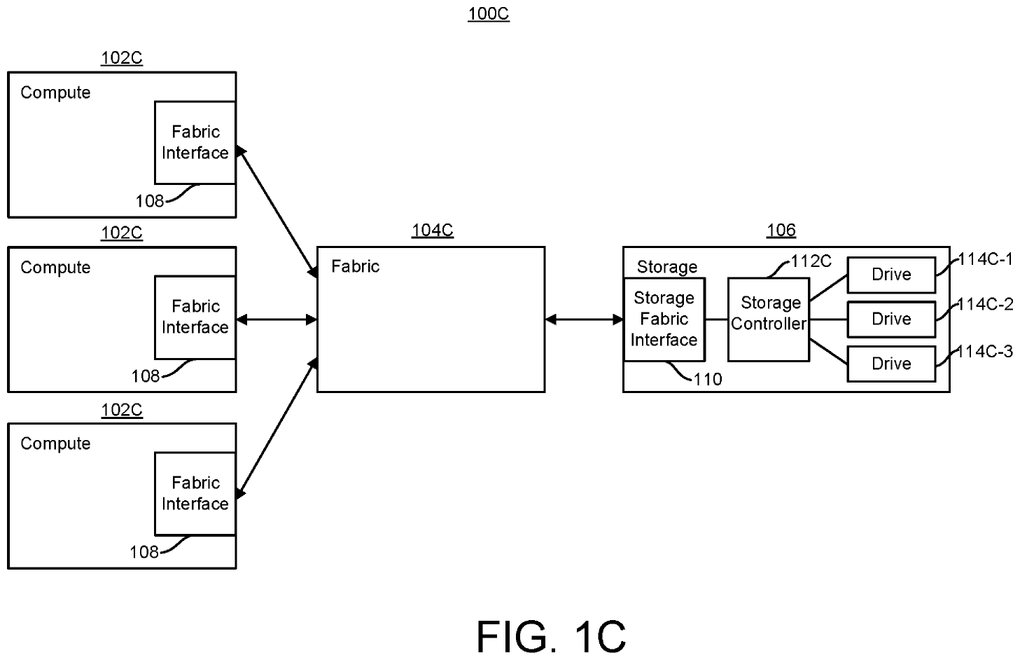

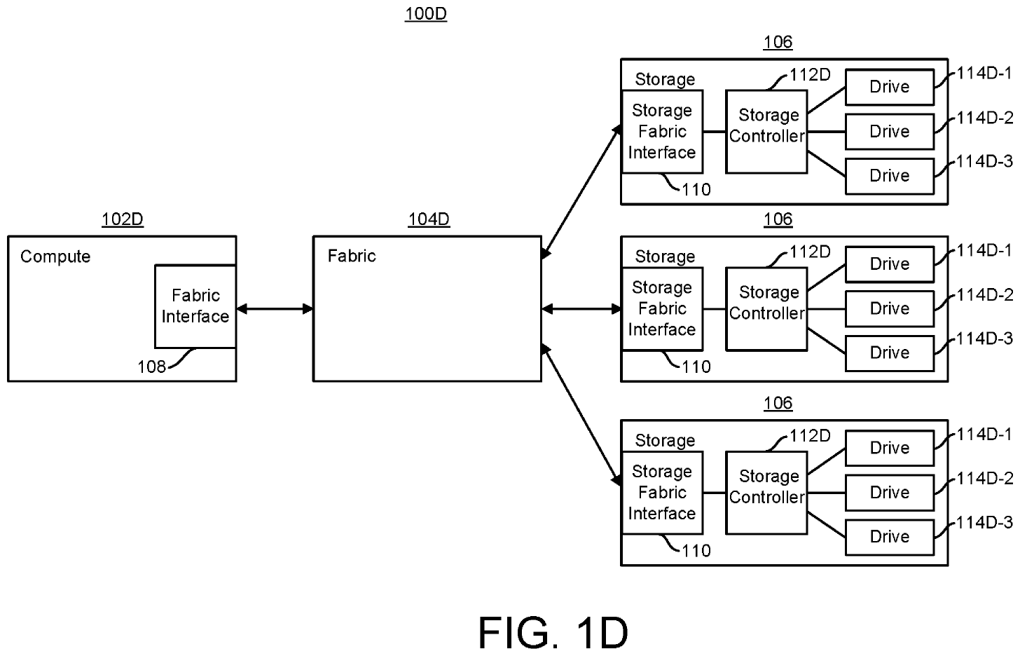

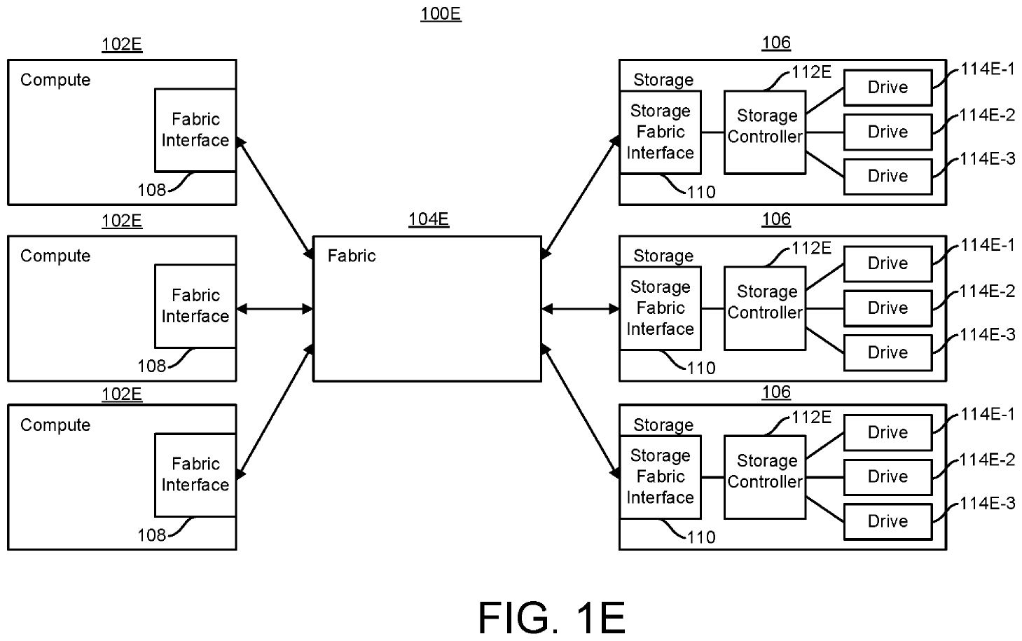

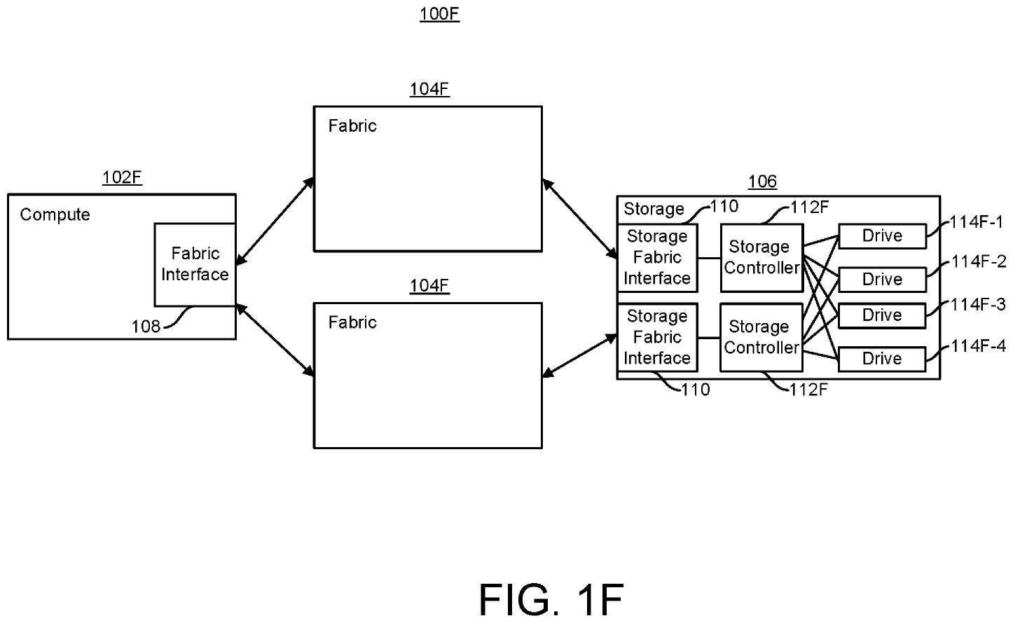

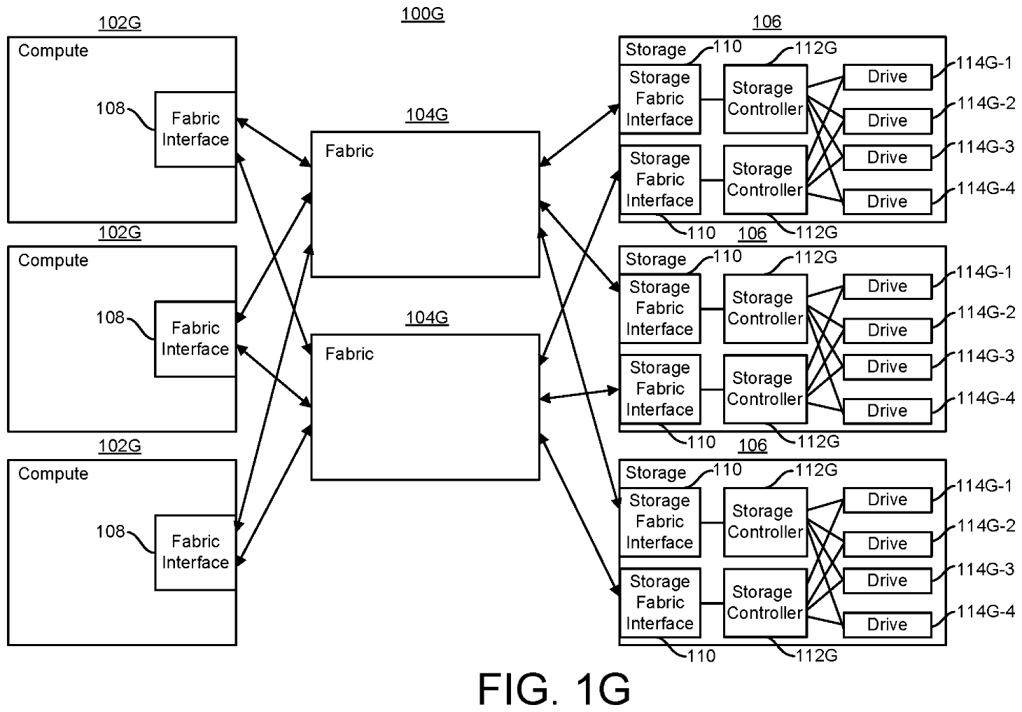

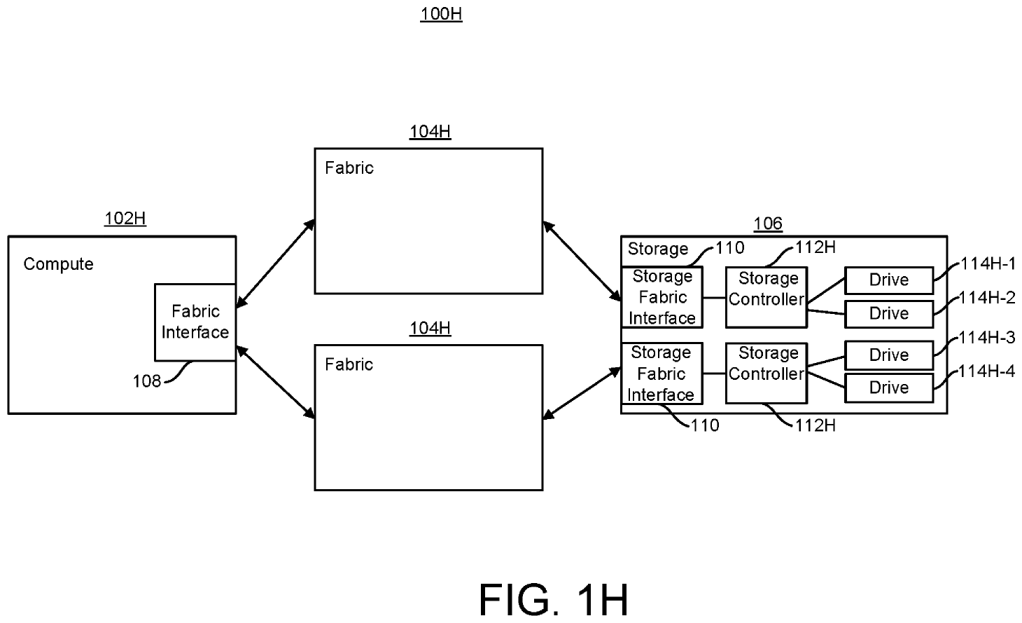

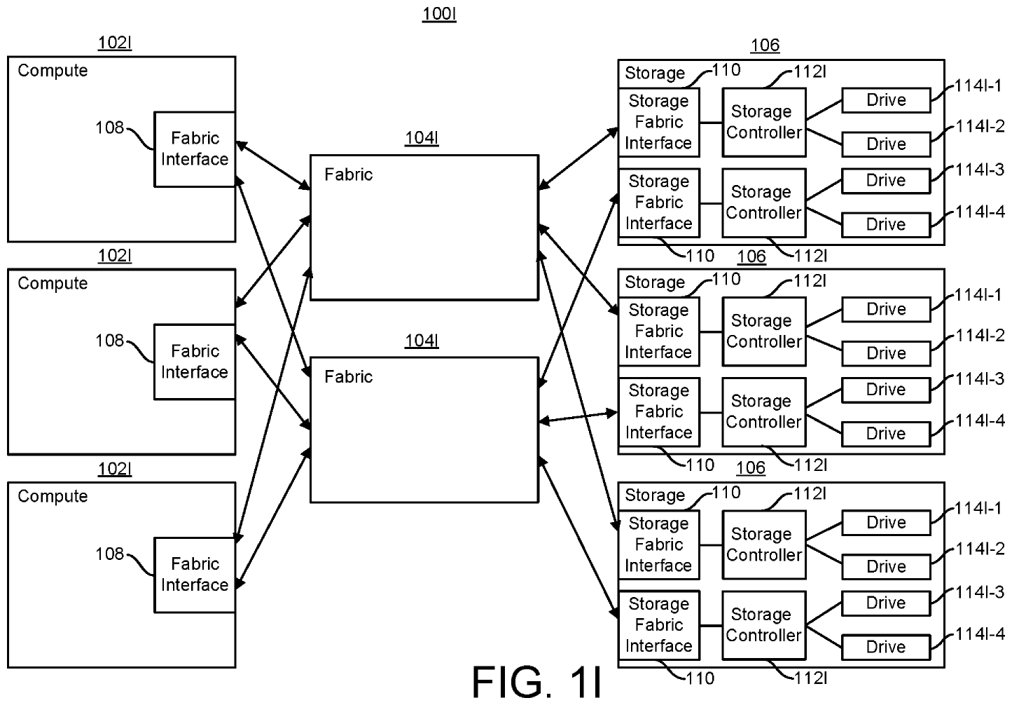

FIG. 1A is an example system 100A for secure storage over fabric, according to one or more examples described. The system 100A may include one or more compute nodes 102A, communication fabrics or fabrics 104A, and storage modules 106. The compute nodes 102A may be computing platforms, such as compute nodes, servers, laptop computers, mobile computers, desktop computers, and the like. The compute nodes 102A may store and access encrypted data over the fabrics 104A to the storage modules 106. The compute nodes 102A may initiate a process that results in the secure storage or retrieval of data from the storage modules 106. Accordingly, the compute nodes 102A are also referred to herein as initiators. The storage modules 106 may be considered the targets of the initiators' requests to store and retrieve data. Accordingly, the storage modules 106 are also referred to herein as targets. The system 100A may include one or more fabrics 104A, for example, cabling to external storage, cabling through Fabric Switches, and connecting through backplane boards. As the fabrics 104A may provide paths between the initiator compute node 102A and the target storage modules 106, the fabrics 104A may be referred to as paths, e.g., single or multiple paths.

The compute nodes 102A may include a fabric network interface card (NIC) 108. The compute nodes 102A may include one or more fabric network interface cards (NICs). Each fabric network interface card 108 may be a network communication apparatus capable of performing computer network communications. Each fabric network interface card 108 may include an encryption capability. The encryption capability may encrypt one or more blocks of data for transmission to the storage modules 106. Each fabric network interface card 108 may include a decryption capability. The decryption capability may decrypt one or more blocks of data received by the fabric network interface card 108 from the storage modules 106 through the fabrics 104A. The encryption and or the decryption capability may include the necessary hardware and software components to encrypt and or decrypt data. The compute nodes 102A and or each fabric network interface card 108 may include one or more encryption keys for encrypting and or decrypting the one or more blocks of data. Each compute node 102A and or fabric network interface card 108 may include an encryption accelerator that may encrypt data that is being sent to the storage modules 106 for storage. Additionally, each compute node 102A and or fabric network interface card 108 may include a decryption accelerator that decrypts data that is retrieved from the storage modules 106. One or more fabric network interface cards 108 may include a firewall for security, a layer ⅔ switch for traffic steering, performance acceleration capabilities, and network visibility that may include remote NIC or network management.

Each fabric network interface card 108 may encrypt and decrypt one or more blocks of data to create one or more encrypted blocks of data. The one or more blocks of data may include one or more files, portions of files, updates to files, and or any number of data packets. The length of the one or more blocks of data may be any length from one data packet to a continuous stream of data packets over some period of time.

A key management entity, not shown, may generate the one or more encryption keys, manage the one or more encryption keys for encryption and or decryption, and may store each encryption key on compute nodes 102A and or one or more fabric network interface cards 108. In examples, a network or server management station may act as the key management entity. The network management station may be a server that may run a network management application. Network devices may communicate with the network management server to relay management and control information. The network management server may also enable network data analysis and reporting.

The network management station may send commands to the one or more fabric network interface cards 108 via a baseboard management controller, not shown, to control the one or more fabric network interface cards 108. The baseboard management controller may connect to the one or more fabric network interface cards 108 via an inter IC or I2C bus, not shown. The baseboard management controller may act as a passthrough to an 12C bus that connects to a management CPU that may be resident on the one or more fabric network interface cards 108.

Each of the one or more encryption keys may be sent to, retrieved from, or erased from the compute nodes 102A and or one or more fabric network interface cards 108 by the key management entity for encryption and decryption purposes. Metadata associated with the one or more encryption keys and any associated stored encrypted data may be managed by the key management entity and may be stored on the compute nodes 102A and or one or more fabric network interface cards 108 and or elsewhere. For example, one or more associated IP addresses of the storage modules 106 and the namespaces to access any stored encrypted data on the storage modules 106 along with any redundant arrays of independent disks (RAID) requirements may be sent by the key management entity to the compute nodes 102A and or one or more fabric network interface cards 108 for encryption and decryption purposes.

The encryption capability may encrypt the one or more blocks of data. The one or more blocks of data may be delivered to the compute nodes 102A already encrypted by another encryption capability (not shown) and then encrypted by software or hardware within the fabric network interface card 108. The encryption capability may be resident within the compute nodes 102A or within the fabrics 104A. For example, if a CPU within the compute nodes 102A executes an encryption/decryption algorithm in software, hardware, or combinations thereof, the algorithm may use the one or more encryption keys to encrypt each data block within the one or more blocks of data before writing the one or more blocks of encrypted data to the storage modules 106 over the fabrics 104A. If the fabric network interface card 108 has a resident capability to execute the encryption/decryption algorithm, in software, hardware, or combinations thereof, the algorithm may use the one or more encryption keys to encrypt each data block within the one or more blocks of data before writing the one or more blocks of encrypted data to the storage modules 106 over the fabrics 104A. Similarly, for reading the one or more blocks of encrypted data from the storage modules 106, either the CPU within the compute nodes 102A or the fabric network interface card 108 may use the appropriate encryption key to decrypt the one or more blocks of encrypted data before passing the one or more unencrypted data blocks to an operating system or one or more applications.

Metadata may be associated with the one or more encrypted blocks of data and the associated encryption key used to encrypt the data for use during decryption. The metadata associated with the encryption key may be associated with the metadata associated with the one or more blocks of encrypted data. The metadata may be stored on the compute node 102A for later use during retrieval and decryption of any amount of encrypted data stored on the storage module 106. The decryption capability may decrypt the one or more blocks of encrypted data after retrieval from the storage module 106. The metadata may be used by the compute node 102A to determine which encryption key to utilize during the decryption process.

The fabrics 104A may be a computer communications network that enables the compute nodes 102A to directly access the storage modules 106. In this way, the compute nodes 102A may perform reads and writes to the storage modules 106 without making calls to intervening software layers, such as an operating system.

The storage modules 106 may be nodes that provide data storage and retrieval capabilities over the fabrics 104A. Example storage modules 106 may include non-volatile memory express (NVMe) external storage, Gen-Z persistent memory, and the like. The storage modules 106 may include one or more storage fabric interfaces 110, storage controllers 112A, and drives 114A-1 to 114A-3 (also referred to collectively as drives 114A or individually and generally as a drive 114A). The storage fabric interface 110 may be network communications apparatus capable of performing computer network communications over the fabrics 104A. Accordingly, the storage fabric interface 110 may receive requests from the compute nodes 102A to write encrypted data to storage and read encrypted data from storage. When receiving requests to write encrypted data to storage, the storage fabric interface 110 may partition the encrypted data sent by the compute nodes 102A and provide the encrypted data to the storage controller 112A to write each partition to different drives 114A, recording metadata about each partition for later partition retrieval. The drives 114A-1 to 114A-3 may be storage devices, such as one or more memory devices, hard disk drives, solid state drives, RAID, virtual drives, and the like.

Because the data may be written across multiple drives 114A, the physical removal of a single drive 114A does not give access to all data of the compute nodes 102A. Further, because the data stored on the drives 114A-1 to 114A-3 may be encrypted, the data at rest on the drives 114A may not be read even if the drives 114A are physically removed.

The system 100A may provide an additional level of security to hypertext transfer protocol secure (HTTPS). HTTPS may provide secure communication over a computer network using Transport Layer Security. In HTTPS, individual data packets may be encrypted. Some of these data packets may include the data payload. Other data packets may be relevant to the communication protocol. In examples of the system 100A, the data payload, being stored and retrieved on and from the drives 114A, may itself be encrypted using an encryption key specific to the compute nodes 102A and or the one or more fabric network interface cards 108. Additionally, the whole data packet carrying the encrypted data payload may be further encrypted according to the HTTPS protocol.

The system 100A may be implemented in various configurations, depending on whether single or multiple components describe in greater detail with respect to FIGS. 1B through 1I. For example, the system 100A may be implemented with a single initiator or multiple initiators, and single or multiple paths to single or multiple targets. Further, the targets may include single or dual-port drives 114A. A target with single port drives may have the drives 114A divided into sets, whereby each storage fabric interface 110 handles traffic to a first set of drives (not separately shown), distinct from the other drives. A target with dual-port drives 114A may enable the storage fabric interfaces 110 to handle traffic for all the drives 114A of a storage module 106.

The features of FIGS. 1B through 1I that include similar features to FIG. 1A, include like numbering. For example, compute nodes 102A is similar to compute node 102B of FIG. 1B, compute node 102C of FIG. 1C, and so on. For the purpose of clarity, these features are not repeatedly described in the following Figure descriptions but are understood to be similar to the like-numbered features of FIG. 1A.

FIG. 1B is an example system 100B for secure storage over fabric, according to one or more examples described. The example system 100B may represent a single path with a single initiator and a single target for secure storage over fabric. The example system 100B includes a compute node 102B, fabric 104B, and storage 106. The compute node 102B may represent the single initiator that initiates the request to securely store data on the storage 106 over the single path, e.g., the fabric 104B. The storage 106 includes a storage fabric interface 110, a storage controller 112B, and drives 114B (also referenced herein as individual drives 114B-1 through 114B-3).

FIG. 1C is an example system 100C for secure storage over fabric, according to one or more examples described. The example system 100C may represent a single path with multiple initiators and a single target for secure storage over fabric. The example system 100C includes compute nodes 102C, fabric 104C, and storage 106. The compute nodes 102C may represent the multiple initiators that initiate requests to securely store data on the storage 106 over the single path, e.g., the fabric 104C. The storage 106 includes a storage fabric interface 110, a storage controller 112C, and drives 114C (also referenced herein as individual drives 114C-1 through 114C-3).

FIG. 1D is an example system 100D for secure storage over fabric, according to one or more examples described. The example system 100D may represent a single path with a single initiator and multiple targets for secure storage over fabric. The example system 100D includes a compute node 102D, fabric 104D, and storages 106. The compute node 1026 may represent the single initiator that initiates the request to securely store data on multiple targets, e.g., storages 106, over the single path, e.g., fabric 104D. The storages 106 include a storage fabric interface 110, a storage controller 112D, and drives 114D (also referenced herein as individual drives 114D-1 through 114D-3).

FIG. 1E is an example system 100E for secure storage over fabric, according to one or more examples described. The example system 100E may represent a single path with multiple initiators and multiple targets for secure storage over fabric. The example system 100E includes compute nodes 102E, fabric 104E, and storages 106. The compute nodes 102E may represent the multiple initiators that initiate requests to securely store data on multiple targets, e.g., storages 106, over the single path, e.g., fabric 104E. The storages 106 includes a storage fabric interface 110, a storage controller 112E, and drives 114E (also referenced herein as individual drives 114E-1 through 114E-3).

FIG. 1F is an example system 100F for secure storage over fabric, according to one or more examples described. The example system 100F may represent multiple paths with a single initiator and multiple-path single target with multiple-port drives. The example system 100F includes a compute node 102F, multiple fabrics 104F, and storage 106. The compute node 102F may represent the single initiator that initiates requests to securely store data on a single target, e.g., storage 106, over multiple paths, e.g., fabrics 104F and storage fabric interfaces 110. The storage 106 includes storage fabric interfaces 110, storage controllers 112F, and drives 114F (also referenced herein as individual drives 114F-1 through 114F-4).

FIG. 1G is an example system 100G for secure storage over fabric, according to one or more examples described. The example system 100G may represent multiple paths with multiple initiators and multiple targets for secure storage over fabric. The example system 100G includes compute nodes 102G, fabrics 104G, and storages 106. The compute nodes 102G may represent the multiple initiators that initiate requests to securely store data on multiple targets, e.g., storages 106, over multiple paths, e.g., the fabrics 104G. The storages 106 includes storage fabric interfaces 110, storage controllers 112G, and drives 114G (also referenced herein as individual drives 114G-1 through 114G-4).

FIG. 1H is an example system 100H for secure storage over fabric, according to one or more examples described. The example system 100H may represent multiple paths with a single initiator and a dual-path target with single-port drives for secure storage over fabric. The example system 100H includes a compute node 102H, fabrics 104H, and storage 106. The compute node 102H may represent the single initiator that initiates requests to securely store data on a dual-path target, e.g., storage 106, over multiple paths, e.g., fabrics 104H. The storage 106 includes storage fabric interfaces 110, storage controllers 112H, and drives 114H (also referenced herein as individual drives 114H-1 through 114H-4).

FIG. 1I is an example system 100I for secure storage over fabric, according to one or more examples described. The example system 100J may represent multiple paths with multiple initiators and multiple targets with single-port drives for secure storage over fabric. The example system 100I includes compute nodes 102I, fabrics 104I, and storages 106. The compute nodes 102I may represent the multiple initiators that initiate requests to securely store data on multiple targets, e.g., storages 106, over single paths, e.g., the fabrics 104I. The storages 106 include storage fabric interfaces 110, storage controllers 112I, and drives 114I (also referenced herein as individual drives 114I-1 through 114I-3).

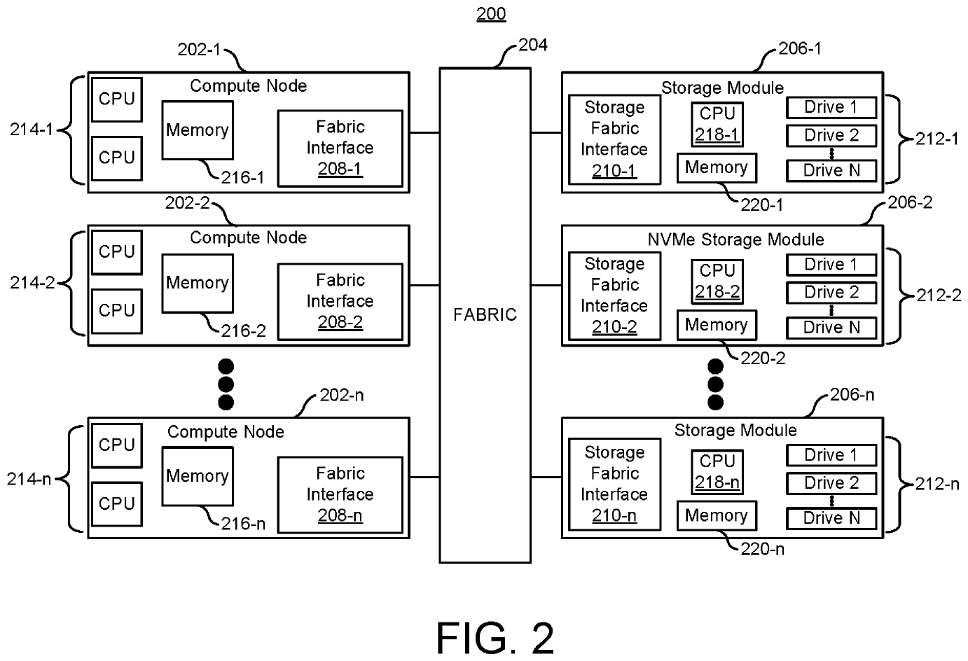

FIG. 2 is an example system 200 for secure storage over fabric, according to one or more examples described. The system 200 may include multiple compute nodes 202-1 to 202-n, a fabric 204, and multiple storage modules 206-1 to 206-n. The system 200 may protect the data for each compute node 202 by distributing the data across the multiple drives 212-1 to 212-n of multiple storage modules 206. The drives 212-1 to 212-n are also referred to collectively as drives 212 or individually and generally as a drive 212.

The storage modules 206-1 to 206-n may be one or more redundant array of independent disks (RAIDs). A RAID may be a data storage technology that combines physical disk drive devices into logical units in order to provide data redundancy and low latency. The compute nodes 202-1 to 202-n may include central processing units (CPUs) 214-1 to 214-n, memories 216-1 to 216-n, and fabric network interface cards 208-1 to 208-n. The storage modules 206-1 to 206-n may include embedded storage fabric interface 210-1 to 210-n, CPUs 218-1 to 218-n, memories 220-1 to 220-n, and drives 212-1 to 212-n. The CPUs 214, 218 may be general-purpose computer processors that execute programmed instructions. The memories 216, 220 may be memory devices, such as dual in-line memory modules (DIMMs) that provide random access memory. The memories 216, 220 may include a disaggregated array of independent storage from the fabric to include a redundant array of independent disks. The fabric network interface cards 208-1 to 208-n may be similar to the fabric network interface cards 108 described with respect to FIG. 1A. Additionally, the storage fabric interface 210-1 to 210-n may be similar to the storage fabric interface 110 described with respect to FIG. 1A. Further, the drives 212-1 to 212-n may be similar to the drives 114A described with respect to FIG. 1A.

Referring back to FIG. 2, the system 200 may secure the data in flight between the compute nodes 202 and storage modules 206 by encrypting and decrypting the data at the compute nodes 202. More specifically, the memory 216-1 may include computer instructions that are being read and executed by the CPUs 214-1. Further, one of the CPUs 214-1 may make a call to one or more of the fabric network interface cards 208-1 to write data to the storage module 206-1 over the fabric 204. To secure data in flight, the one or more of the fabric network interface cards 208-1 may encrypt the data using one or more encryption keys that are stored or maintained on the compute node 202-1. After encrypting the data, the fabric network interface cards 208-1 may make a call to the storage module 206-1 to store the encrypted data.

Securing the data in flight at the compute node 202 may be transparent and compatible to all application programs running on that compute node 202. Further, if the encryption/decryption is handled by an accelerator such as a Smart IO device, then the security may be transparent and compatible with any operating system or hypervisor, with only a driver for the Smart IO device.

In examples, the system 200 may provide separate encryption keys for each compute node 202. As such, the data in flight from each compute node 202 to the storage modules 206 may be uniquely encrypted. Thus, even if a single encryption key is stolen, only the compute node 202 to which the encryption key is assigned is compromised. The security of the remaining compute nodes 202 may remain protected against snooping on the fabric 204.

In some examples, the system 200 may provide multiple encryption keys for each compute node 202. In this way, multiple blocks of data in flight from a compute node 202 to the storage module 206 may be uniquely encrypted. In this way, the security of data in flight may be increased. For example, if one of the storage modules 206-1 through 206-n is compromised, only the stream of data assigned to the compromised storage module may be vulnerable to snooping. If one of the encryption keys is compromised, only the stream of data assigned to the compromised encryption key may be vulnerable to snooping.

In response to the request to store the data, the storage module 206-1 may stripe the encrypted data across several of the drives 212. Striping data may involve partitioning data into blocks and writing each block to a different one of the drives 212. More specifically, the embedded storage fabric interface 210-1 may partition the encrypted data into multiple blocks. Further, the storage fabric interface 210-1 may assign drives 212 randomly for writing each block of the partitioned data. For example, the received data may be partitioned into two blocks. Further, the first block may be assigned to drive 2 for storage, and the second block may be assigned to drive 1. Accordingly, each block may be temporarily written to the memory 220-1. Additionally, the CPU 218-1 may write each block to the assigned drives 212. The data in the storage modules 206-1 may be protected from an attack involving the removal of the memory 220-1 because the data remains encrypted throughout its processing in the storage module 206-1.

In some examples, the storage modules 206 may include redundant controllers to dual-port the drives 212. Dual-porting the drives 212 may provide multiple independent data paths to shared storage, which improves the availability of data.

In some examples, the system 200 may add fabric isolation for the data in flight, such as, fibre channel zoning or Ethernet virtual local area networks (VLANs). Fibre channel zoning may involve the partitioning of the fabric 204 into reduced size subsets.

Advantageously, distribution of the encrypted data across multiple drives 212 in each storage module 206 means that an attacker may be prevented from accessing meaningful data by stealing one drive 212. Rather, the attacker may need more than one drive 212, potentially all the drives 212, in addition to the encryption keys from all the compute nodes, and the location of the data on the drives 212 to recover the data from a single compute node.

Advantageously, no single device in the system 200 may be used by itself to steal data. The compute nodes 202 may have the encryption keys, but the data is on the drives 212 in separate storage module(s) 206. Further, the storage modules 206 may contain all the drives 212, but not the encryption keys. Additionally, a stolen drive 212 may not contain all the data for any compute node 202 if the storage for the compute node 202 is striped across several drives 212. Further, storing partial data stripes for multiple compute nodes 202 on one of the drives 212 may further impede attempts by malicious users to extract the data.

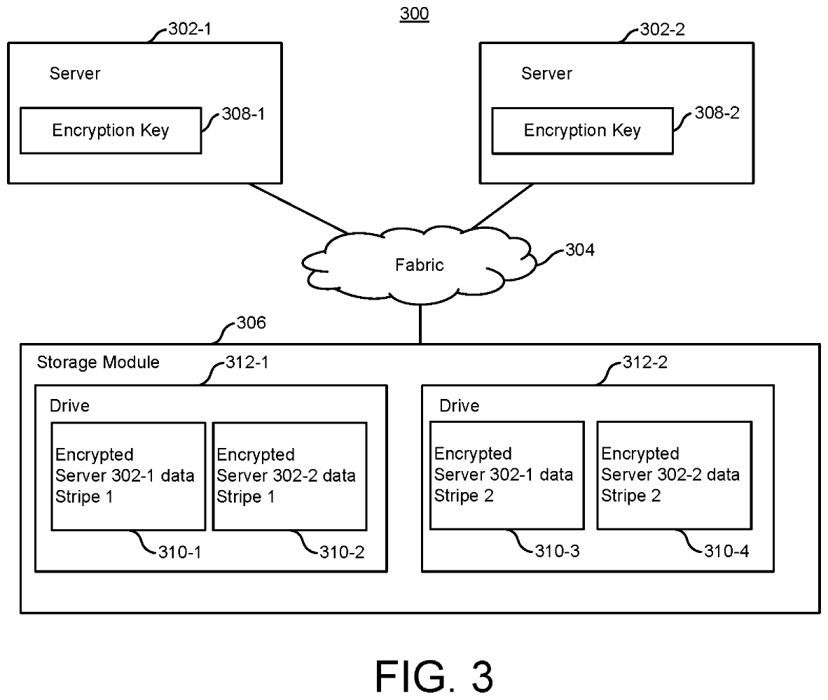

FIG. 3 is an example system 300 for secure storage over fabric, according to one or more examples described. The system 300 shows an example of striping data. The system 300 includes compute nodes 302-1, 302-2, fabric 304, and storage module 306. The compute nodes 302-1, 302-2 may be similar to the compute nodes 102A, 202-1 to 202-n described with respect to FIGS. 1 and 2. The compute nodes 302-1, 302-2 may store data over the fabric 304 in the storage module 306. The compute nodes 302-1, 302-2 may include encryption keys 308-1, 308-2, respectively to encrypt data before sending over the fabric 304 to the storage module 306. The storage module 306 may include drives 312-1, 312-2 for storing the encrypted data received from the compute nodes 302-1, 302-2. In an example, the storage module 306 may receive a request to store data from compute node 302-1. Accordingly, the storage module 306 may partition the data from compute node 302-1, encrypted with encryption key 308-1 into multiple stripes 310-1, 310-3, and assign each stripe to different drives 312-1, 312-2, respectively. Similarly, the storage module 306 may receive data from compute node 302-2 encrypted with encryption key 308-2. The storage module 306 may partition the data from compute node 302-2 into multiple stripes 310-2, 310-4, and assign each stripe to different drives 312-1, 312-2, respectively.

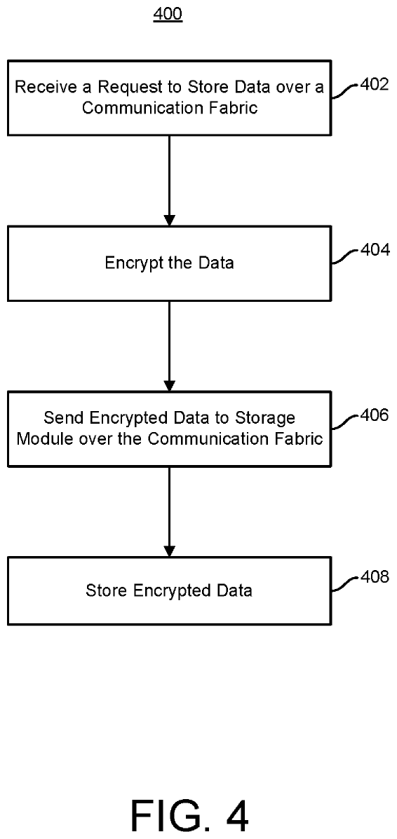

FIG. 4 is a process flow diagram of a method 400 for secure storage over fabric, according to one or more examples described. The method 400 may be performed by a fabric interface, such as fabric network interface card 108 or the storage fabric interface 110, with reference to FIG. 1A. The fabric network interface card 108 or the storage fabric interface 110 may be a smart NIC. At block 402, fabric network interface card 108 may receive a request to store data over a fabric, such as the fabrics 104A. In examples, a compute node, such as the compute nodes 102A may be executing an application. The application may execute an instruction to store data externally and or to encrypt the data to be stored externally. Accordingly, the application may encrypt the data and or make a call to the fabric network interface card 108 to store the data over the fabrics 104A.

At block 404, the fabric network interface card 108 may encrypt the data to be stored using an encryption accelerator. In examples, the compute nodes 102A may include an encryption key for storing data over the fabrics 104A. In some examples, the compute nodes 102A may include multiple encryption keys, one for each stream of data sent over the fabrics 104A. Accordingly, the encryption accelerator of the compute nodes 102A may use different encryption keys to encrypt each stream of data.

At block 406, the fabric network interface card 108 may send the encrypted data to a storage module, such as the storage modules 106 over the fabrics 104A. By sending the data encrypted, the fabric network interface card 108 may protect the data in flight from a malicious user snooping on the fabrics 104A.

At block 408, the storage fabric interface 110 may store the encrypted data on a memory device, such as drive 114A-1 or 114A-2. At block 408, the storage fabric interface 110 may store a first portion of the encrypted data on a first memory device, such as drive 114A-1. Additionally, the storage fabric interface 110 may store a second portion of the encrypted data on a second memory device, such as the drive 114A-2. In examples, the storage fabric interface 110 may partition the encrypted data received from the compute nodes 102A into the multiple partitions. Further, the storage fabric interface 110 may randomly assign each of the partitions to one of the drives 114A. Additionally, the encrypted data may be protected by the encryption key. The encryption key may be stored on the fabric network interface card 108 or on the compute node 102A.

It is to be understood that the process flow diagram of FIG. 4 is not intended to indicate that the method 400 is to include all of the blocks shown in FIG. 4 in every case. Further, any number of additional blocks may be included within the method 400, depending on the details of the specific implementation. In addition, it is to be understood that the process flow diagram of FIG. 4 is not intended to indicate that the method 400 is only to proceed in the order indicated by the blocks shown in FIG. 4 in every case. For example, block 404 may be rearranged to occur before block 402.

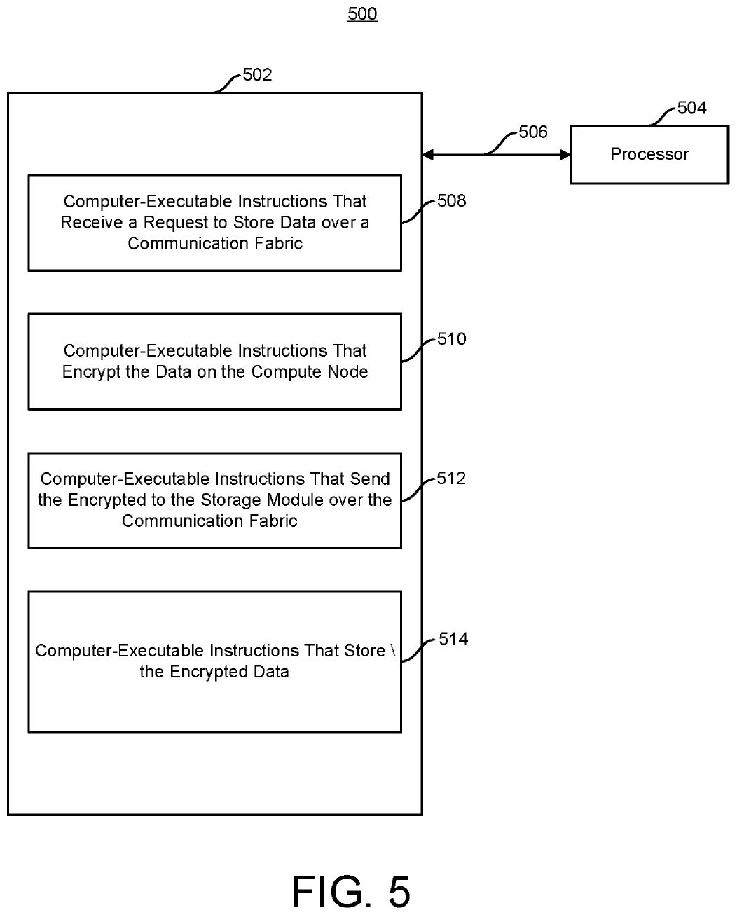

FIG. 5 is an example system 500 comprising a tangible, non-transitory computer-readable medium 502 that stores code for securing node groups, according to one or more examples described. The tangible, non-transitory computer-readable medium is generally referred to by the reference number 502. The tangible, non-transitory computer-readable medium 502 may correspond to any typical computer memory that stores computer-implemented instructions, such as programming code or the like. For example, the tangible, non-transitory computer-readable medium 502 may include RAM, ROM, EEPROM, CD-ROM or other optical disk storage, magnetic disk storage or other magnetic storage components, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

The tangible, non-transitory computer-readable medium 502 may be accessed by a processor 504 over a computer bus 506. The processor 504 may be a central processing unit that is to execute an operating system in the system 500. A region 508 of the tangible, non-transitory computer-readable medium 502 may store computer-executable instructions that receive a request to store data using a storage module that is connected with a compute node over a fabric. The compute node may include one or more encryption keys. The compute node may include a first network communication apparatus including an encryption capability. The storage module may include a second network communication apparatus. A region 510 of the tangible, non-transitory computer-readable medium may store computer-executable instructions that encrypt the data using a first encryption key and may use an encryption accelerator to encrypt the data. A region 512 of the tangible, non-transitory computer-readable medium may store computer-executable instructions that may send the encrypted data from the compute node to the storage module over the fabric. A region 514 of the tangible, non-transitory computer-readable medium may store computer-executable instructions that may store a first portion of the encrypted data on a first memory device of the storage module and may store a second portion of the encrypted data on a second memory device of the storage module. A region 514 of the tangible, non-transitory computer-readable medium may store computer-executable instructions that may store a first portion of the encrypted data on a first plurality of memory devices of the storage module and may store a second portion of the encrypted data on a second plurality of memory devices of the storage module. In examples, the second network communication apparatus may parse or generate the first portion of the encrypted data and the second portion of the encrypted data. The second network communication apparatus may specify that the first portion of the encrypted data be stored on the first memory device and that the second portion of the encrypted data be stored on the second memory device.

Although shown as contiguous blocks, the software components may be stored in any order or configuration. For example, if the tangible, non-transitory computer-readable medium 502 is a hard drive, the software components may be stored in non-contiguous, or even overlapping, sectors.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for securing storage over a fabric connection, comprising:
receiving a request to store one or more blocks of data using a storage module that is connected with a compute node over a fabric, wherein:
the compute node comprises a fabric network interface card with a resident encryption capability; and the storage module comprises a storage fabric interface for receiving encrypted data;
encrypting the data utilizing the resident encryption capability to create a first encrypted data set; and
sending the first encrypted data set from the fabric network interface card to the storage module over the fabric, wherein metadata is associated with the first encrypted data set and the metadata is stored on the compute node.

2. The method of claim 1, wherein the storage module stores a first portion of the first encrypted data set on a first storage device in the storage module, and wherein the storage module stores a second portion of the first encrypted data set on a second storage device in the storage module.

3. The method of claim 2, wherein:
the storage module comprises a redundant array of independent disks;
the first portion of the first encrypted data set is stored on a first plurality of memory devices; and
the second portion of the first encrypted data set is stored on a second plurality of memory devices.

4. The method of claim 2, wherein the compute node comprises a first encryption key, the data is encrypted with the first encryption key, metadata is associated with the first encryption key, and the metadata associated with the first encryption key is associated with the metadata associated with the first encrypted data set.

5. The method of claim 4, further comprising:
receiving an additional request to store one or more additional blocks of data using the storage module, wherein the storage module is connected with an additional compute node over the fabric;
encrypting the one or more additional blocks of data, wherein the additional compute node comprises a second encryption key, and the one or more additional blocks of data is encrypted with the second encryption key to create a second encrypted data set; and
sending the second encrypted data set from the additional compute node to the storage module over the fabric, wherein the storage module stores a first additional portion of the second encrypted data set on the first storage device of the storage module, and wherein the storage module stores a second additional portion of the second encrypted data set on the second storage device of the storage module.

6. The method of claim 1, wherein the fabric network interface card comprises an encryption accelerator, and wherein encrypting the data comprises the encryption accelerator encrypting the data.

7. The method of claim 1, wherein the storage module comprises non-volatile memory express storage.

8. The method of claim 1, wherein the storage module comprises a disaggregated array of independent storage from the fabric to comprise a redundant array of independent disks.

9. The method of claim 1, further comprising a compute node memory, wherein the compute node memory comprises a disaggregated array of independent storage from the fabric to comprise a redundant array of independent disks.

10. The method of claim 1, further comprising:
sending a request to the storage module to retrieve a portion of the first encrypted data set;
receiving the portion of the first encrypted data set over the fabric; and
decrypting the portion of the first encrypted data set utilizing the encryption key associated with the first encrypted data set.

11. A system comprising:
a processor; and
a memory that stores instructions that cause the processor to:
receive a request to store one or more blocks of data using a storage module that is connected with a compute node over a fabric, wherein the compute node comprises a first fabric network interface card with a resident encryption capability; and the storage module comprises a storage fabric interface for receiving encrypted data ;
encrypt the data utilizing the resident encryption capability and a first encryption key to create a first encrypted data set; and
send the first encrypted data set from the fabric network interface card to the storage module over the fabric, wherein metadata associated the first encrypted data set with the first encryption key is stored on the compute node.

12. The system of claim 11, wherein:
the storage module stores a first portion of the first encrypted data set on a first memory device of the storage module, and wherein the storage module stores a second portion of the first encrypted data set on a second memory device of the storage module;
the storage module comprises a storage fabric interface;
the storage fabric interface manages the storage of the first portion of the first encrypted data set and the second portion of the first encrypted data set; and
the storage fabric interface specifies that the first portion of the first encrypted data set is stored on the first memory device and that the second portion of the first encrypted data set is stored on the second memory device.

13. The system of claim 12, wherein:
the storage module comprises a redundant array of independent disks;
the first portion of first encrypted data set is stored on a first plurality of memory devices; and
the second portion of first encrypted data set is stored on a second plurality of memory devices.

14. The system of claim 12, wherein the compute node comprises two or more encryption keys.

15. The system of claim 14, wherein the instructions cause the processor to:
receive an additional request to store one or more additional blocks of data using the storage module, wherein the storage module is connected with an additional compute node over the fabric;
encrypt one or more additional blocks of data using an additional encryption accelerator of the additional compute node, wherein the additional compute node comprises a second encryption key, and the one or more additional blocks of data is encrypted with the second encryption key to create a second encrypted data set; and
send the second encrypted data set from the additional compute node to the storage module over the fabric, wherein the storage module stores a first additional portion of the second encrypted data set on the first memory device of the storage module, and wherein the storage module stores a second additional portion of the second encrypted data set on the second memory device of the storage module.

16. The system of claim 11, wherein the storage module comprises a non-volatile memory express storage module.

17. The system of claim 11, wherein the storage module comprises a Gen-Z persistent memory.

18. A non-transitory, computer-readable medium storing computer-executable instructions, which when executed, cause a computer to:
receive a request to store data using a storage module that is connected with a compute node over a fabric, wherein:
the compute node comprises a first network communication apparatus comprising the encryption; and
the storage module comprises a second network communication apparatus;
encrypt the data on the compute node; and
send the encrypted data from the compute node to the storage module over the fabric, wherein:
the storage module stores a first portion of the encrypted data on a first memory device of the storage module;
the storage module stores a second portion of the encrypted data on a second memory device of the storage module;
the second network communication apparatus generates the first portion of the encrypted data and the second portion of the encrypted data; and
the second network communication apparatus specifies that the first portion of the encrypted data is stored on the first memory device and that the second portion of the encrypted data is stored on the second memory device.

19. The non-transitory, computer-readable medium of claim 18, wherein the data is encrypted with a first encryption key, and wherein the compute node comprises the first encryption key and a second encryption key.

20. The non-transitory, computer-readable medium of claim 18, wherein:
the storage module comprises a redundant array of independent disks;
the first portion of encrypted data is stored on a first plurality of memory devices; and
the second portion of encrypted data is stored on a second plurality of memory devices.
